(19) United States
(12) Patent Application Publication
(10) Pub. No.: US 2014/0060578 A1
(43) Pub. Date: Mar. 6, 2014

(54) Robotic Carpet and Rug Deep Cleaner

(71) Applicant: Milliken & Company, Spartanburg, SC (US)

(72) Inventor: Robert C. Tomlinson, Greer, SC (US)

(73) Assignee: Milliken & Company, Spartanburg, SC (US)

(21) Appl. No.: 13/974,097

(22) Filed: Aug. 23, 2013

Related U.S. Application Data
(60) Provisional application No. 61/693,817, filed on Aug. 28, 2012.

(51) Int. Cl. A47L 11/32; A47L 11/40

(52) U.S. Cl. CPC A47L 11/32; A47L 11/4083; A47L 11/4061
USPC 134/6; 15/41.1

(57) ABSTRACT

This invention combines multiple tasks associated with carpet deep cleaning. It includes a self-propelled cleaner and guide system that will dispense, brush and retrieve a dry carpet cleaning pretreatment and powder across the surface of the carpet.

### CROSS REFERENCE TO RELATED APPLICATIONS

This application claims priority to U.S. Provisional Patent Application No. 61/693,817, entitled “Robotic Carpet and Rug Deep Cleaner” which was filed on Aug. 28, 2012.

### TECHNICAL FIELD

This invention combines multiple tasks associated with carpet deep cleaning. It includes a self-propelled cleaner and guide system that will dispense, brush and retrieve a dry carpet cleaning pretreatment and powder across the surface of the carpet.

### BACKGROUND

Carpet and rug cleaning typically requires a human being for guidance and operation. Most machines and systems are water based and require frequent changes in fresh and retrieved (dirty) water by the operator and are not self-guided, propelled or operated. It is not practical to have water lines hooked into such a unit as the lines could tangle or risk leaks and spills. Large water storage tanks are also not a feasible option as they increase machine weight and would be cumbersome to change. Thus, the best option for a self-propelled and guided deep carpet cleaner is to develop a cleaner that dispenses and retrieves an absorbent cleaning powder.

There have been advancements by others in this area in the development and marketing of self-propelled vacuum cleaners. At least one describes the use of a mapping system associated with a self-propelled vacuum. In addition, others have developed powder dispensing systems. However, none have combined the functionalities of both systems into a self-propelled and guided carpet cleaning, dispensing, and vacuuming machine.

### BRIEF SUMMARY

This invention relates to a self-propelled and guided carpet and rug robotic cleaner that dispenses, brushes, and retrieves a powder cleaning composition.

In one aspect, the invention relates to a carpet or rug cleaning system comprising: (a) a self-propelled and guided robotic cleaner that includes: a powder dispensing chamber for dispensing a powder cleaning composition, a brushing mechanism, optionally a retrieval chamber, and a power source; and (b) a guidance system. The robotic cleaning system may further comprise a pretreatment dispensing chamber for dispensing an aqueous cleaning solution.

In one aspect, the powder cleaning composition may be comprised of: between 0.1% and 75% by weight of at least one absorbent particulate selected from the group consisting of a urea formaldehyde polymeric material, polyurethane, polystyrene, phenol-formaldehyde resin particles, water insoluble inorganic salt adjuvants, cellulosic particles, diatomaceous earth particles, wood particles, particles made from grains and other vegetable matter, inorganic particles and mixtures thereof, wherein the absorbent particulate has an average particle size of from about 10 to about 300 microns in diameter and an oil absorption value of at least 40; between 0.1% and 20% by weight of at least one super absorbent polymer selected from the group consisting of cross-linked polyacrylic acid compounds; between 20% and 90% by weight of water, wherein the water contains a surfactant sufficient to provide a surface tension of less than about 40 dynes per centimeter; and between 0.01% and 10% by weight of at least one additive selected from an organic liquid, a stain resist agent, a pH adjuster, a biocide, a static reducing additive, a dust suppressing additive, a vacuum retrieval additive, a metal ion chelator, and a fragrance.

In yet another aspect, the powder cleaning composition may be comprised of: between 10% and 65% by weight of at least one absorbent particulate selected from the group consisting of a urea formaldehyde polymeric material, polyurethane, polystyrene, phenol-formaldehyde resin particles, water insoluble inorganic salt adjuvants, cellulosic particles, diatomaceous earth particles, wood particles, particles made from grains and other vegetable matter, inorganic particles and mixtures thereof, wherein the absorbent particulate has an average particle size of from about 10 to about 300 microns in diameter and an oil absorption value of at least 40; between 1% and 10% by weight of at least one super absorbent polymer selected from the group consisting of cross-linked polyacrylic acid compounds; between 30% and 70% by weight of water, wherein the water contains a surfactant sufficient to provide a surface tension of less than about 40 dynes per centimeter; and between 0.01% and 10% by weight of at least one additive selected from an organic liquid, a stain resist agent, a pH adjuster, a biocide, an aerosol propellant, a static reducing additive, a dust suppressing additive, a vacuum retrieval additive, a metal ion chelator, and a fragrance.

In yet a further aspect, the powder cleaning composition is comprised of: between 25% and 60% by weight of at least one absorbent particulate selected from the group consisting of a urea formaldehyde polymeric material, polyurethane, polystyrene, phenol-formaldehyde resin particles, water insoluble inorganic salt adjuvants, cellulosic particles, diatomaceous earth particles, wood particles, particles made from grains and other vegetable matter, inorganic particles and mixtures thereof, wherein the absorbent particulate has an average particle size of from about 10 to about 300 microns in diameter and an oil absorption value of at least 40; between 3% and 8% by weight of at least one super absorbent polymer selected from the group consisting of cross-linked polyacrylic acid compounds; between 40% and 60% by weight of water, wherein the water contains a surfactant sufficient to provide a surface tension of less than about 40 dynes per centimeter; and between 0.01% and 10% by weight of at least one additive selected from an organic liquid, a stain resist agent, a pH adjuster, a biocide, an aerosol propellant, a static reducing additive, a dust suppressing additive, a vacuum retrieval additive, a metal ion chelator, and a fragrance.

In yet a further aspect, the invention relates to a process for cleaning a carpet or rug comprising the steps of: (a) providing a self-propelled and guided robotic cleaner that contains a dispensing chamber, a brushing mechanism, and optionally a retrieval chamber; (b) adding a powder cleaning composition to the dispensing chamber; (c) placing transmitter or sensing markers in an area to be cleaned; (d) activating the robotic cleaner by applying power to the cleaner; (e) allowing the cleaner to operate for a length of time in a first pass over the carpet or rug, wherein the cleaner dispenses the powder cleaning composition onto the surface of the carpet or rug; (f) allowing the cleaner to operate for a length of time in a second pass over the carpet or rug, wherein the brushing mechanism is activated to brush the cleaning composition into the surface of the carpet or rug; (g) allowing the robotic cleaner to enter a rest state for a period of time, and (h) allowing the robotic cleaner to retrieve the cleaning composition.

### BRIEF DESCRIPTION OF THE DRAWINGS

FIG. 1A is a top view of the robotic carpet and deep rug cleaner.

FIG. 1B is a bottom view of the robotic carpet and deep rug cleaner.

FIG. 2 is a schematic diagram illustrating one embodiment of the operation of the robotic carpet and rug cleaner.

FIG. 3 is a side view of the robotic carpet and deep rug cleaner.

### DETAILED DESCRIPTION

This invention combines multiple tasks associated with carpet deep cleaning. The robotic cleaner of the present invention is a self-propelled and self-guided system that will dispense, brush and retrieve a dry carpet cleaning pretreatment and/or powder across the surface of a carpet or rug. The robotic cleaner may dispense the pretreatment and/or powder substantially evenly across the surface of a carpet or rug. The robotic cleaner includes a stored power source, such as a battery, for operation. The powder source is preferably rechargeable. The cleaning system may also include a remote control for ease of use by an operator.

Prior to operation, the robotic cleaner is filled with one or more cleaning compositions and placed in the area to be cleaned. To determine the cleaning area, the cleaning system (i.e. the robotic cleaner and guidance system and any other parts that are used in connection with the robotic cleaner) will include a guidance system, such as a GPS and/or a combination of transmitters and receivers, that identify the perimeter of the cleaning area by sensing markers or transmitters that are present in the cleaning area. These sensing markers and/or transmitters help the robotic cleaner identify the perimeter reference points and are placed in the cleaning area by the operator prior to cleaning to aid the robotic cleaner in sensing the cleaning area.

As one exemplary embodiment, an internal mapping system with sensors (e.g. stairway sensors, bumper sensors, and the like), processors, and optionally at least one camera, may be employed as the guidance system that provides navigation information to the robotic cleaner. One such internal mapping system that may be ideal for use with the robotic cleaner of the present invention is disclosed in U.S. Pat. No. 7,805,220 to Taylor et al., which is entirely incorporated by reference herein.

After the robotic cleaner is powered up, it will sense the perimeter markers and begin moving within those markers. As it begins to move it will begin dispensing the pretreatment and/or cleaning composition (“cleaning materials”) onto the surface of the carpet or rug. A brushing mechanism may also be activated to brush the pretreatment and/or cleaning composition into the surface of the carpet or rug. The brushing mechanism may operate at the same time as the pretreatment and/or cleaning composition is being dispensed, or it may operate in a second pass over the carpet or rug after the dispensing step is completed

The robotic cleaner will dispense the pretreatment and/or cleaning composition in any pattern as it moves over the surface of the carpet or rug. For example, it may move in a back and forth pattern, a circular pattern, etc. It may move forward and backward or it may only move in a forward direction. The robotic cleaner will continue to move over the surface of the carpet until it has dispensed the cleaning materials over the entire area to be cleaned. The robotic cleaner may dispense the cleaning materials in a substantially uniform manner. Preferably, the robotic cleaner will avoid moving over areas that have already been passed over. If the robotic cleaner dispenses all of the cleaning materials prior to completing its course over the carpet or rug, it will signal the operator to add more cleaning materials.

The robotic cleaner may be programmed to operate in a rest state while the cleaning materials are given time to clean the carpet or rug and/or to allow the cleaning materials to dry. For example, the robotic cleaner may rest in an idle state for approximately 15 minutes, or 30 minutes, or 45 minutes, or one hour.

After the optional rest period has elapsed, the robotic cleaner will power back up and retrace its path in vacuum mode. While in vacuum mode, the robotic cleaner may move in any direction and/or pattern that allows it to retrieve the cleaning materials. For example, it may move forward and backward, or it may move in a circular pattern. In this manner, the robotic cleaner retrieves the cleaning materials that have been dispensed.

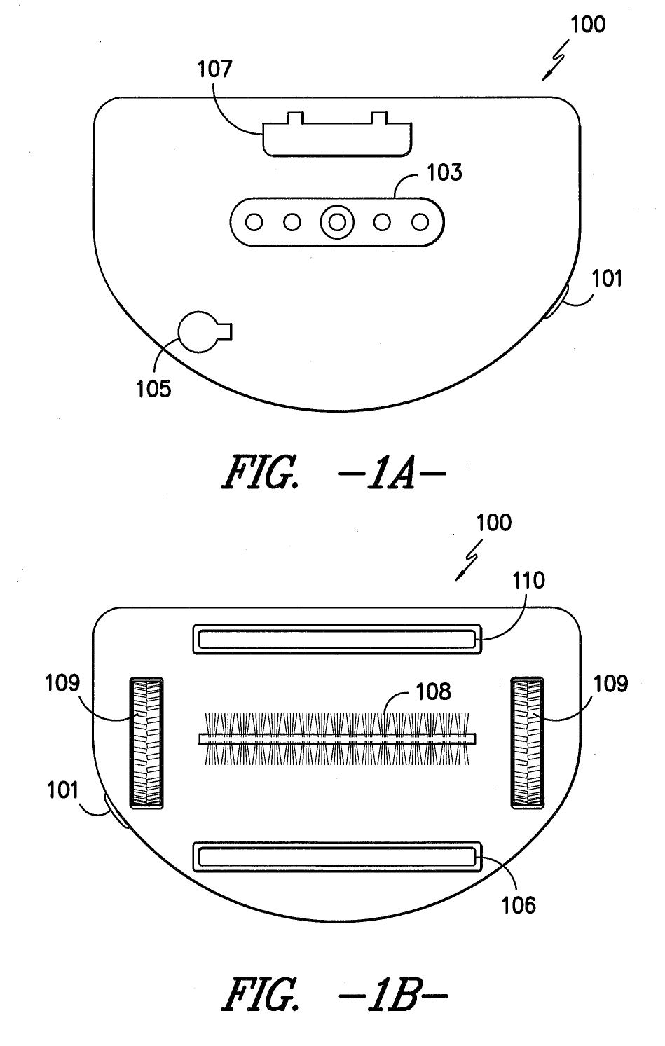

FIG. 1A illustrates the top view of one embodiment of the robotic cleaner 100 of the present invention. As shown, the robotic cleaner has wheels 109 for ease of movement over a carpet or rug. Opening 105 is provided for adding the powder cleaning composition to the robotic cleaner 100. Power buttons 103 are provided which are utilized by the operator to begin movement of the robotic cleaner 100. A flip up cover 107 is provided which allows the use to empty the contents of the material that has been vacuumed up from the carpet or rug. Charging outlet 101 is provided so that the operator can re-charge the robotic cleaner after use.

FIG. 1B illustrates the bottom view of one embodiment of the robotic cleaner 100 of the present invention. Dispensing chamber 106 is provided as an opening for spreading the powder cleaning composition onto the surface of the carpet or rug. The powder cleaning composition is added to the robotic cleaner through opening 105 shown in FIG. 1A. Brushing mechanism 108 is provided to agitate the powder cleaning composition into the surface of the carpet or rug. Retrieval chamber 110 is provided to allow retrieval of the powder cleaning composition from the carpet or rug. The powder cleaning composition, and any other materials present on the carpet or rug, is vacuumed up through retrieval chamber 110 and is stored in an area which is accessed by flip up opening 107 shown in FIG. 1A.

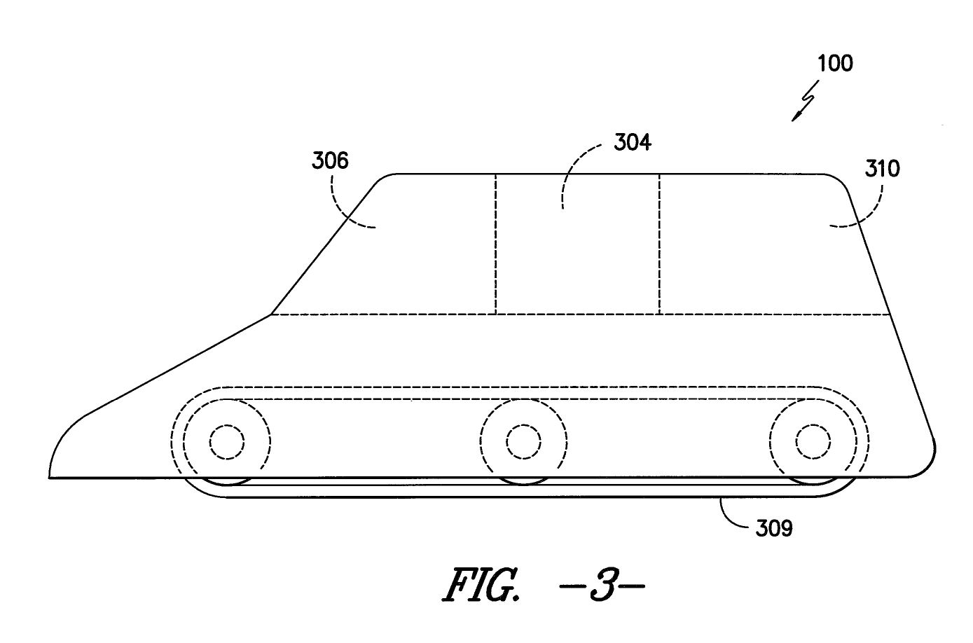

FIG. 3 illustrates the side view of one embodiment of the robotic cleaner 100 of the present invention. Storage bin 306 is shown as an area where the powder cleaning composition is stored in robotic cleaner 100. Vacuum motor and retrieval bin 310 is an area of the robotic cleaner where the vacuum motor may be located and where a compartment or bin is separately located for collecting the material that is vacuumed up from the surface being cleaned. Robotic cleaner 100 includes a battery compartment 304 for storing a battery. The battery provides energy for operating the robotic cleaner. While wheels 109 are illustrated in FIG. 1A as means for allowing movement of the robotic cleaner over the flooring surface, rubber track 309 is illustrated here in FIG. 3 as an alternative means for allowing movement of the robotic cleaner over the flooring surface.

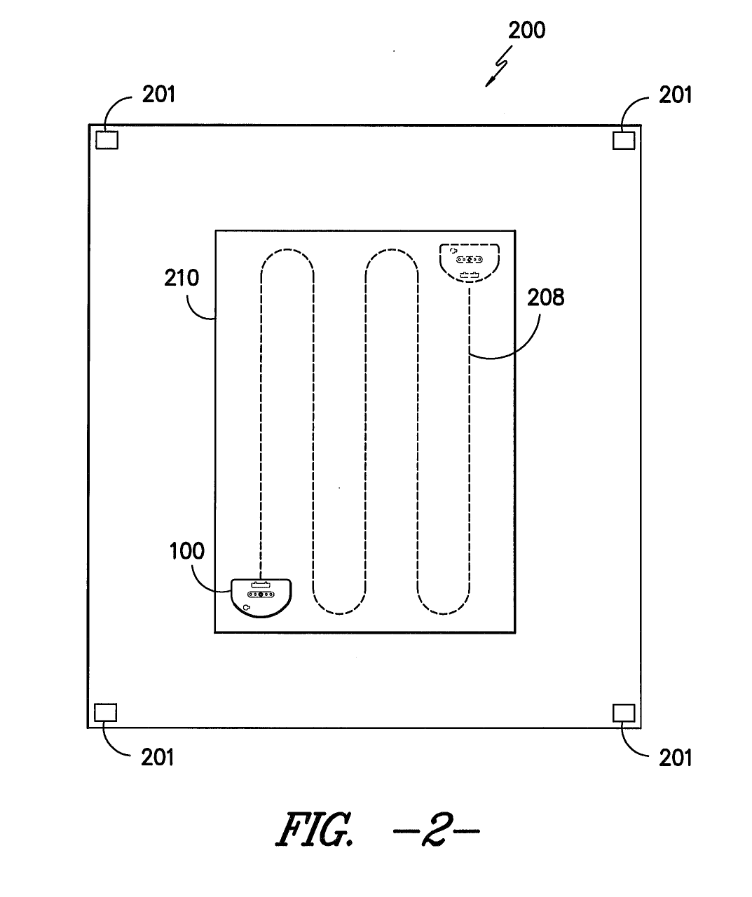

FIG. 2 illustrates one embodiment of the operation of robotic cleaner 100. A room 200 is shown that contains a carpet or rug 210. A guidance system 201 is provided which communicates with the robotic cleaner 100, allowing it to maneuver robotically over the surface of the carpet or rug. Robotic cleaner 100 is shown in operation mode moving in a back and forth pattern 208 over the surface of carpet or rug 210.

The powder cleaning composition generally comprises an absorbent particulate material, a super absorbent polymer, and other ingredients. Other ingredients include, without limitation, organic liquids, surfactants, surface active agents, static reducing additives, dust suppressing additives, vacuum retrieval additives, metal ion chelators, stain resist agents, pH adjusters, fragrance, biocides, water, and the like. The absorbent particulate material, super absorbent polymer and other ingredients comprising the powder cleaning composition may be present in any of a number of combinations, as may be determined by the specific end-use of the powder cleaning composition.

The absorbent particulate materials may be selected from a wide variety of solid materials. The solid materials may include naturally occurring materials, such as wood particles (like sawdust or wood flour), particles made from grains and other vegetable matter, diatomaceous earth particles, cellulosic particles and inorganic particles (such as silicates, borates, etc.). The solid material may also be a synthetic material, such as a synthetic resin material. Synthetic resin materials include, for example, urea formaldehyde polymer, such as those disclosed in commonly assigned U.S. Pat. Nos. 4,434,067 and 4,908,149. Other synthetic resin materials include, for example, polyurethane, polystyrene, and phenol-formaldehyde resin particles, similar to the type disclosed in French Patent No. 2,015,972 assigned to Henkel Et Co Gmbh. Still other absorbent particulate materials include water insoluble inorganic salt adjuvants such as, for example, sulfates, carbonates (such as calcium carbonate), borates, citrates, phosphates, metasilicates and mixtures thereof.

The absorbent particulate material may be present in the composition in an amount between 0.1% and 75% by weight based on the total weight of the composition, more preferably between 10% and 65% by weight based on the total weight of the composition, and even more preferably between 25% and 60% by weight based on the total weight of the composition.

Average particle size of the absorbent particulate material may be from about 10 microns to about 300 microns in diameter as determined by sieve analysis. It may be more preferable that the average particle size of the particulate is from about 10 microns to about 200 microns in diameter as determined by sieve analysis. It may be even more preferable that the average particle size of the particulate material is from about 10 microns to about 105 microns in diameter as determined by sieve analysis. It may yet be even more preferable that the average particle size of the particulate is from about 35 microns to about 105 microns as determined by sieve analysis. In general, it may be preferable for some applications that the particle size distribution should be such that not more than about 10 percent of the particles are larger than about 105 microns and in general no more than about 5 percent of the particles are smaller than about 10 microns. Larger particles typically do not penetrate carpet material adequately, and use of such particles would result in only superficial cleaning at best. Larger particles also have insufficient surface area to absorb a large amount of soil per unit of weight. If the particles are smaller than about 10 microns in diameter, they may adhere to the individual carpet fibers and have a delustering or dulling effect on the color of the carpet. While particles between about 10 and 35 microns may be tolerated, they may not contribute to cleaning efficiency to any substantial extent so that the average particle size should be in excess of 35 microns.

The absorbent particles may be further characterized by the classical Critical Pigment Volume (CPV) effect, also known as the oil value or oil absorption value. This value may be determined by ASTM D281 and is described, for example, in U.S. Pat. No. 3,956,162 to Lautenberger. To remain a flowable powder, the maximum liquid content is restricted to below the oil absorption value. For particles of a certain shape, the oil absorption value is the volume between particles filled with air. As the air is displaced by a fluid, the flow properties of the powder are reduced until, at the oil absorption value, all the particles are surrounded by liquid. Accordingly, it may be preferred that the absorbent particles have an oil absorption value of at least 40. It may be more preferable that the absorbent particles have an oil absorption value of at least 60.

One potentially preferred, non-limiting solid material for use in such compositions is the type which has been disclosed in U.S. Pat. No. 4,013,594 to Froehlich et al. wherein particulate, polymeric urea formaldehyde particles were proposed for use in dry-type cleaning compositions. These particulate urea formaldehyde materials were distinguished in the Froehlich patent from those of the earlier French Patent No. 2,015,972 based upon a fairly broad range of parameters. Of particular interest was the disclosure that the particles described in the Froehlich patent, as compared to the particles of the French patent, possessed a somewhat higher bulk density of at least about 0.2 grams per cubic centimeter. Such higher bulk density characteristics resulted in generally increased cleaning effectiveness as compared to the prior art particles. With respect to urea formaldehyde particles, it is noted that these particles may contain approximately 35-40% moisture content when manufactured.

Super absorbent polymers (“SAPs”) may include those polymers made from partially neutralized, lightly cross-linked poly(acrylic) acid compounds. Several commercially available super absorbent polymers that may suitable for incorporation into the present cleaning composition include the Luquasorb® products available from BASF, such as Luquasorb® 1010, Luquasorb® 1003, Luquasorb® MA 1110 and the Hysorb™ products available from BASF such as Hysorb™ 8400.

It has also been noted that some super absorbent polymers change color over time and exhibit shades of yellow or brown. These particular SAPs may be less desirable for use, since it is intended that the powdered cleaning composition remain white in color.

It is believed that smaller particle size SAPs absorb liquid much faster due to increased surface area. Thus, particle size of the dry SAPs may be in the range of 20-600 microns in diameter, more preferably in the range of 40-300 microns in diameter, and even more preferably in the range of 40-100 microns in diameter. It may be most preferable that the particle size of the SAPs is in the range of 60-80 microns in diameter. After absorbing liquid, the wet SAPs may swell to a size of 80-100 microns in diameter.

Super absorbent polymers may be present in the composition in an amount between 0.1% and 20% by weight based on the total weight of the composition, more preferably between 1% and 10% by weight based on the total weight of the composition, and even more preferably between 3% and 8% by weight based on the total weight of the composition.

Typically, the presence of between 3% to 8% of SAP in the composition allows the water content of the composition to be in the range of 55% to 80% and still maintain a powdered cleaning composition that has good flow properties. The presence of the SAP in the composition does not detrimentally affect the cleaning properties of the composition. Rather, it has been found that the cleaning properties are as good as that observed from cleaning substrates with the comparison composition that does not contain the SAP. Additionally, the retrieval properties (the ability to remove all, or nearly all, of the composition from the substrate being cleaned) are improved over the composition that does not contain the SAP.

The following other ingredients or additives may be present in the powder cleaning composition in amounts ranging between 0.01% and 10% by weight based on the total weight of the composition. Other ingredients include, without limitation, organic liquids, surfactants, surface active agents, static reducing additives, dust suppressing additives, vacuum retrieval additives, metal ion chelators, stain resist agents, pH adjusters, fragrance, biocides, water, and the like. However, as will be discussed below, the amount of water may be present in amounts that are higher than this range.

Examples of organic liquids which can be used include, without limitation, C₁ to C₄ aliphatic alcohols, high boiling hydrocarbon solvents, and mixtures thereof. The hydrocarbon solvents are generally the petroleum distillates with a boiling point between about 100° C. and about 300° C. Low boiling organic liquids are generally unsuitable from a standpoint of vapors and flammability, and higher boiling organic liquids do not evaporate from the textile substrate at an adequately rapid rate. Examples of commercially available hydrocarbon solvents include Stoddard solvent and odorless hydrocarbon solvent. These solvents usually consist of a petroleum distillate with a boiling point between about 105° and about 200° C. Properties of these solvents are comparable to those of British Standard White Spirits and domestic mineral spirits. Chemically, these solvents consist of a number of hydrocarbons, principally aliphatic, in the decane region. One potentially preferred, non-limiting organic liquid is a high boiling hydrocarbon solvent. Organic liquids may be present in the powder cleaning composition in amounts ranging between 0.01% and 10% by weight.

Surfactants of a number of classes are satisfactory for use in the powder cleaning composition. The selection of a surfactant is not critical but the surfactant should serve to lower the surface tension of the water in the composition to about 40 dynes per centimeter or less. Preferred anionic surfactants are long chain alcohol sulfate esters, such as those derived from C₁₀-C₁₈ alcohols sulfated with chlorosulfonic acid and neutralized with an alkali. Also preferred are alkylene oxide additives of C₆-C₁₀ mono and diesters of ortho-phosphoric acid. Representative nonionic surfactants that can be used have the formula:

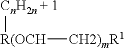

where n is 0 or 1, m is 3 to 20, R¹ is OH or OCH₃, R is C₁₂ to C₂₂ alkyl or phenyl or naphthyl optionally substituted by C₁ to C₁₀ alkyl groups.

The surfactant can be a nonionic surfactant or a mixture of a nonionic surfactant and either an anionic surfactant or a cationic surfactant. Mixtures of anionic and cationic surfactants are suitable only in carefully selected cases. A preferred composition contains from about 1 to about 4% nonionic surfactant. A satisfactory mixture of commercial anionic surfactants comprises (1) 0.4% of the sodium salt of a mixture of C₁₀-C₁₈ alcohol sulfates, predominantly C₁₂, (2) 0.4% of the diethylcyclohexylamine salt of the same sulfate mix, and (3) 0.2% of the product formed by reacting a mixture of n-octyl mono and diesters of ortho-phosphoric acid with sufficient ethylene oxide to form a neutral product, ordinarily about 2 to 4 moles of ethylene oxide per mole of phosphoric ester.

Surfactants may be present in the powder cleaning composition in amounts ranging between 0.01% and 10% by weight. However, the surfactant may more preferably be present in amounts ranging from about 0.5 to about 5.0% by weight.

Vacuum retrieval additives include, for example, compounds such as polyoxyalkylene materials (such as dipropylene glycol), aluminum silicate clay, hydrolyzed styrene maleic anhydride, and mixtures thereof. Polyoxyalkylene materials (such as dipropylene glycol), as well as non-volatile organic solvents (such as mineral oil), and mixtures thereof may also be used as dust suppressing additives. Aluminum silicate clay may also be used as a static reducing additive. Metal ion chelators include such compounds, for example, as ethylene diamine tetraacetic acid (EDTA). Stain resist agents include such compounds as, for example, acrylic stain blockers. Such compounds as aqua ammonia, citric acid, and mixtures thereof may be included as pH adjusters. Biocides may be included to prolong the shelf life of the cleaning composition. These may include, for example, compounds such as potassium sorbate, isothiazolones and mixtures thereof. Fragrances may also be included in the composition to impart a desirable odor to the composition. Any of the above ingredients or additives may be present in the powder cleaning composition in amounts ranging between 0.01% and 10% by weight.

The amount of water added to the cleaning composition may depend on the amount of super absorbent polymer adding to the powder cleaning composition. However, in general, it may be desirable that the amount of water added to the composition is between 20% and 90% based on the total weight of the composition. It may be more preferable that the amount of water added to the composition is between 30% and 70% based on the total weight of the composition. It may be most preferable that the amount of water added to the composition is between 40% and 60% based on the total weight of the composition. In some instances, it may ideal that the amount of water is greater than the amount of absorbent particulate material present in the composition.

Thus, it may be ideal that the powder cleaning composition is comprised of between 0.1% and 75% by weight of at least one absorbent particulate material; between 0.1% and 20% by weight of at least one super absorbent polymer; between 20% and 90% by weight of water, wherein the water may also contain a surfactant sufficient to provide a surface tension of less than about 40 dynes per centimeter; and between 0.01% and 10% by weight of at least one additive selected from an organic liquid, a stain resist agent, a pH adjuster, a biocide, a static reducing additive, a dust suppressing additive, a vacuum retrieval additive, a metal ion chelator, and a fragrance.

It may be more preferable that the cleaning composition is comprised of between 10% and 65% by weight of at least one absorbent particulate material; between 1% and 10% by weight of at least one super absorbent polymer; between 30% and 70% by weight of water, wherein the water may also contain a surfactant sufficient to provide a surface tension of less than about 40 dynes per centimeter; and between 0.01% and 10% by weight of at least one additive selected from an organic liquid, a stain resist agent, a pH adjuster, a biocide, a static reducing additive, a dust suppressing additive, a vacuum retrieval additive, a metal ion chelator, and a fragrance.

Further, it may be preferable that the cleaning composition is comprised of between 25% and 60% by weight of at least one absorbent particulate material; between 3% and 8% by weight of at least one super absorbent polymer; between 40% and 60% by weight of water, wherein the water may also contain a surfactant sufficient to provide a surface tension of less than about 40 dynes per centimeter; and between 0.01% and 10% by weight of at least one additive selected from an organic liquid, a stain resist agent, a pH adjuster, a biocide, a static reducing additive, a dust suppressing additive, a vacuum retrieval additive, a metal ion chelator, and a fragrance.

In preparing the powdered cleaning composition, it may be desirable to add the super absorbent polymer to the absorbent particulate material and then immediately add the water. This may prevent the super absorbent polymer from dehydrating the absorbent particulate itself. Also, it may be ideal that the super absorbent particulate is properly hydrated, prior to its addition to the composition.

The present invention eliminates the need for a hands-on operator to clean carpets and rugs. The self-propelled and guided robotic cleaner requires very little supervision. Essentially, it transforms s a very difficult and physical cleaning experience into a simple and easy to use tool.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A carpet or rug cleaning system comprising:
(a) a self-propelled and guided robotic cleaner that includes:
(i) a powder dispensing chamber for dispensing a powder cleaning composition,
(ii) a brushing mechanism,
(iii) optionally, a retrieval chamber, and
(iv) a power source, and,
(b) a guidance system.

2. The carpet or rug cleaning system of claim 1, wherein the robotic cleaner further comprises a pretreatment dispensing chamber for dispensing an aqueous cleaning solution.

3. The carpet or rug cleaning system of claim 1, wherein the powder cleaning composition is comprised of:
(a) between 0.1% and 75% by weight of at least one absorbent particulate selected from the group consisting of a urea formaldehyde polymeric material, polyurethane, polystyrene, phenol-formaldehyde resin particles, water insoluble inorganic salt adjuvants, cellulosic particles, diatomaceous earth particles, wood particles, particles made from grains and other vegetable matter, inorganic particles and mixtures thereof, wherein the absorbent particulate has an average particle size of from about 10 to about 300 microns in diameter and an oil absorption value of at least 40;
(b) between 0.1% and 20% by weight of at least one super absorbent polymer selected from the group consisting of cross-linked polyacrylic acid compounds;
(c) between 20% and 90% by weight of water, wherein the water contains a surfactant sufficient to provide a surface tension of less than about 40 dynes per centimeter; and
(d) between 0.01% and 10% by weight of at least one additive selected from an organic liquid, a stain resist agent, a pH adjuster, a biocide, a static reducing additive, a dust suppressing additive, a vacuum retrieval additive, a metal ion chelator, and a fragrance.

4. The carpet or rug cleaning system of claim 3, wherein the average particle size of the at least one absorbent particulate is from about 35 to about 105 microns.

5. The carpet or rug cleaning system of claim 3, wherein the at least one absorbent particulate is urea formaldehyde polymeric material.

6. The carpet or rug cleaning system of claim 3, wherein the water insoluble inorganic salt adjuvant is selected the group consisting of sulfates, carbonates, borates, citrates, phosphates, metasilicates and mixtures thereof.

7. The carpet or rug cleaning system of claim 6, wherein the water insoluble inorganic salt adjuvant is calcium carbonate.

8. The carpet or rug cleaning system of claim 3, wherein the powder cleaning composition comprises between 10% and 65% by weight of at least one absorbent particulate.

9. The carpet or rug cleaning system of claim 3, wherein the powder cleaning composition comprises between 25% and 60% by weight of at least one absorbent particulate.

10. The carpet or rug cleaning system of claim 3, wherein the powder cleaning composition comprises between 1% and 10% by weight of at least one super absorbent polymer.

11. The carpet or rug cleaning system of claim 3, wherein the powder cleaning composition comprises between 3% and 8% by weight of at least one super absorbent polymer.

12. The carpet or rug cleaning system of claim 3, wherein the powder cleaning composition comprises between 30% and 70% by weight of water.

13. The carpet or rug cleaning system of claim 3, wherein the powder cleaning composition comprises between 40% and 60% by weight of water.

14. The carpet or rug cleaning system of claim 3, wherein the surfactant is selected from the group consisting of nonionic surfactants, anionic surfactants, cationic surfactants, and combinations thereof.

15. The carpet or rug cleaning system of claim 14, wherein the surfactant is a nonionic surfactant, and wherein the nonionic surfactant has the formula: 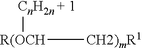
where n is 0 or 1, m is 3 to 20, R¹ is OH or OCH₃, R is C₁₂ to C₂₂ alkyl or phenyl or naphthyl optionally substituted by C₁ to C₁₀ alkyl groups.

16. The carpet or rug cleaning system of claim 14, wherein the surfactant is an anionic surfactant, and wherein the anionic surfactant is a long chain alcohol sulfate ester or an alkylene oxide additive of C₆-C₁₀ mono and diesters of ortho-phosphoric acid.

17. The carpet or rug cleaning system of claim 3, wherein the organic liquid is selected from the group consisting of C₁ to C₄ aliphatic alcohols, high boiling hydrocarbon solvents and mixtures thereof.

18. The carpet or rug cleaning system of claim 3, wherein the biocide is selected from the group consisting of potassium sorbate, an isothiazolone compound and mixtures thereof.

19. The carpet or rug cleaning system of claim 1, wherein the powder cleaning composition is comprised of:
(a) between 10% and 65% by weight of at least one absorbent particulate selected from the group consisting of a urea formaldehyde polymeric material, polyurethane, polystyrene, phenol-formaldehyde resin particles, water insoluble inorganic salt adjuvants, cellulosic particles, diatomaceous earth particles, wood particles, particles made from grains and other vegetable matter, inorganic particles and mixtures thereof, wherein the absorbent particulate has an average particle size of from about 10 to about 300 microns in diameter and an oil absorption value of at least 40;
(b) between 1% and 10% by weight of at least one super absorbent polymer selected from the group consisting of cross-linked polyacrylic acid compounds;
(c) between 30% and 70% by weight of water, wherein the water contains a surfactant sufficient to provide a surface tension of less than about 40 dynes per centimeter; and
(d) between 0.01% and 10% by weight of at least one additive selected from an organic liquid, a stain resist agent, a pH adjuster, a biocide, an aerosol propellant, a static reducing additive, a dust suppressing additive, a vacuum retrieval additive, a metal ion chelator, and a fragrance.

20. The carpet or rug cleaning system of claim 19, wherein the at least one absorbent particulate is urea formaldehyde polymeric material.

21. The carpet or rug cleaning system of claim 1, wherein the powder cleaning composition is comprised of:
(a) between 25% and 60% by weight of at least one absorbent particulate selected from the group consisting of a urea formaldehyde polymeric material, polyurethane, polystyrene, phenol-formaldehyde resin particles, water insoluble inorganic salt adjuvants, cellulosic particles, diatomaceous earth particles, wood particles, particles made from grains and other vegetable matter, inorganic particles and mixtures thereof, wherein the absorbent particulate has an average particle size of from about 10 to about 300 microns in diameter and an oil absorption value of at least 40;
(b) between 3% and 8% by weight of at least one super absorbent polymer selected from the group consisting of cross-linked polyacrylic acid compounds;
(c) between 40% and 60% by weight of water, wherein the water contains a surfactant sufficient to provide a surface tension of less than about 40 dynes per centimeter; and
(d) between 0.01% and 10% by weight of at least one additive selected from an organic liquid, a stain resist agent, a pH adjuster, a biocide, an aerosol propellant, a static reducing additive, a dust suppressing additive, a vacuum retrieval additive, a metal ion chelator, and a fragrance.

22. The carpet or rug cleaning system of claim 21, wherein the at least one absorbent particulate is urea formaldehyde polymeric material.

23. A process for cleaning a carpet or rug comprising the steps of:
(a) providing a self-propelled and guided robotic cleaner that contains a dispensing chamber, a brushing mechanism, and optionally a retrieval chamber;
(b) adding a powder cleaning composition to the dispensing chamber;
(c) placing transmitter or sensing markers in an area to be cleaned;
(d) activating the robotic cleaner by applying power to the cleaner;
(e) allowing the cleaner to operate for a length of time in a first pass over the carpet or rug, wherein the cleaner dispenses the powder cleaning composition onto the surface of the carpet or rug;
(f) allowing the cleaner to operate for a length of time in a second pass over the carpet or rug, wherein the brushing mechanism is activated to brush the cleaning composition into the surface of the carpet or rug;
(g) allowing the robotic cleaner to enter a rest state for a period of time, and
(h) allowing the robotic cleaner to retrieve the cleaning composition.
